(19) United States
(12) Patent Application Publication
(10) Pub. No.: US 2026/0285551 A1
(43) Pub. Date: Sep. 24, 2026

(54) SMALL PARTS STORAGE CONTAINER

(71) Applicant: Lincoln Davidson, Fargo, ND (US)

(72) Inventor: Lincoln Davidson, Fargo, ND (US)

(21) Appl. No.: 19/570,373

(22) Filed: Mar. 18, 2026

Related U.S. Application Data
(60) Provisional application No. 63/774,027, filed on Mar. 18, 2025.

(51) Int. Cl. B65D 43/02; B33Y 80/00; B65D 1/36

(52) U.S. Cl. CPC B65D 43/022; B65D 1/36; B33Y 80/00; B65D 2543/00518

(57) ABSTRACT

A cover for a container assembly includes a top section; a bottom section; a first and second longitudinal side between the top section and the bottom section; and a first and second lateral side between the top section and the bottom section.

### CROSS REFERENCE TO RELATED APPLICATION[S]

The present disclosure claims priority to United States Provisional Patent Disclosure Ser. No. 63/774,027 filed Mar. 18, 2025.

### BACKGROUND

The present disclosure relates to containers, and more specifically to a tray with multiple compartments, each with a removable cover.

There are many storing and organizing systems for storage of electronic devices such as resisters for use in manual repair, rework, and building of circuit boards.

Surface mount resistors are typically provided in reels of tape that typically hold several thousand resistors. The reels of tape are designed for use with automated pick and place equipment for manufacturing circuit boards. The tape has individual compartments for each resistor and a plastic film over the tops of the compartments to prevent the resistors from falling out. This film needs to be peeled back from the compartments in order to access the resistors. But reels of tape are not convenient for storing small quantities and a large assortment of values such as is needed in repair work or hand building of a circuit board.

Existing storage systems such as trays with hinged lids on each compartment, individual containers with removable covers, and 3-ring binders having pages with pockets to hold strips of tape all are workable solutions but have drawbacks that may make them inconvenient. 3-ring binders are bulky and typically hold strips of the tape that contain the components as it comes from a reel of parts. Accessing a component involves first finding the page in the binder that has the part and then removing the strip of tape from a pocket in the binder and finally removing the part from the tape. And then the tape has to be put back into the binder.

Trays with hinged lids are bulky and have the added complexity of the hinge mechanism. Individual containers with removable covers need an additional organizer to store the individual containers.

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A cover for a container assembly according to one disclosed non-limiting embodiment of the present disclosure includes a top section; a bottom section; a first and second longitudinal side between the top section and the bottom section; and; a first and second lateral side between the top section and the bottom section.

A further embodiment of any of the foregoing embodiments of the present disclosure includes, wherein a recess in the top, the recess comprises a lip and an undercut, the undercut forms an acute angle with the surface of the top section, wherein the recess is fingernail shaped.

A further embodiment of any of the foregoing embodiments of the present disclosure includes, wherein a flanged upper section about the top section, the flanged upper section defines a periphery larger than a periphery defined by the sides.

A further embodiment of any of the foregoing embodiments of the present disclosure includes, wherein a chamfered bottom section about the bottom section, the chamfered bottom section defines a periphery smaller than a periphery defined by the sides.

A further embodiment of any of the foregoing embodiments of the present disclosure includes, wherein the first and second longitudinal side define an interference fit within a compartment in a tray within which the cover is installed.

A further embodiment of any of the foregoing embodiments of the present disclosure includes, wherein the interference fit is between 101-105% the length of the longitudinal length of the compartment.

A further embodiment of any of the foregoing embodiments of the present disclosure includes, wherein the first and second lateral side define a clearance fit within a compartment in a tray within which the cover is installed.

A further embodiment of any of the foregoing embodiments of the present disclosure includes, wherein the first and second longitudinal side define an interference fit within a compartment in a tray within which the cover is installed and the first and second lateral side define a clearance fit within a compartment in a tray within which the cover is installed.

A further embodiment of any of the foregoing embodiments of the present disclosure includes, wherein the interference fit is between 101-105% the length of the longitudinal length of the compartment.

A further embodiment of any of the foregoing embodiments of the present disclosure includes, wherein the cover and the tray are additively manufactured.

A further embodiment of any of the foregoing embodiments of the present disclosure includes, wherein the cover and the tray are additively manufactured of different materials.

A further embodiment of any of the foregoing embodiments of the present disclosure includes, wherein the cover and the tray are injection molded.

A further embodiment of any of the foregoing embodiments of the present disclosure includes, wherein the cover and the tray are injection molded of different materials.

A further embodiment of any of the foregoing embodiments of the present disclosure includes, wherein a recess in the bottom section.

A container assembly according to one disclosed non-limiting embodiment of the present disclosure includes a tray with a multiple of compartments; a cover that fits at least partially within at least one of the multiple of compartments, the cover comprises: a top section; a first and second longitudinal side between the top section and a bottom section; and a first and second lateral side between the top section and the bottom section, wherein the first and second longitudinal side define an interference fit within a compartment in a tray within which the cover is installed and the first and second lateral side define a clearance fit within the compartment in the tray within which the cover is installed.

A further embodiment of any of the foregoing embodiments of the present disclosure includes a recess in the top section, the recess comprises a lip and an undercut that forms an acute angle with the surface of the top section.

A further embodiment of any of the foregoing embodiments of the present disclosure includes an interference fit that is between 101-105% the length of the longitudinal length of the compartment.

The foregoing features and elements may be combined in various combinations without exclusivity, unless expressly indicated otherwise. These features and elements as well as the operation thereof will become more apparent in light of the following description and the accompanying drawings. However, it should be appreciated that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a container assembly according to one disclosed non-limiting embodiment.

FIG. 2A is a longitudinal side view of a cover according to one disclosed non-limiting embodiment.

FIG. 2B is a lateral side view of a cover according to one disclosed non-limiting embodiment.

FIG. 3A is a sectional longitudinal side view of a cover according to one disclosed non-limiting embodiment.

FIG. 3B is a sectional lateral side view of a cover according to one disclosed non-limiting embodiment.

FIG. 4A-4C are perspective sectional views of a cover according to one disclosed non-limiting embodiment.

### DETAILED DESCRIPTION

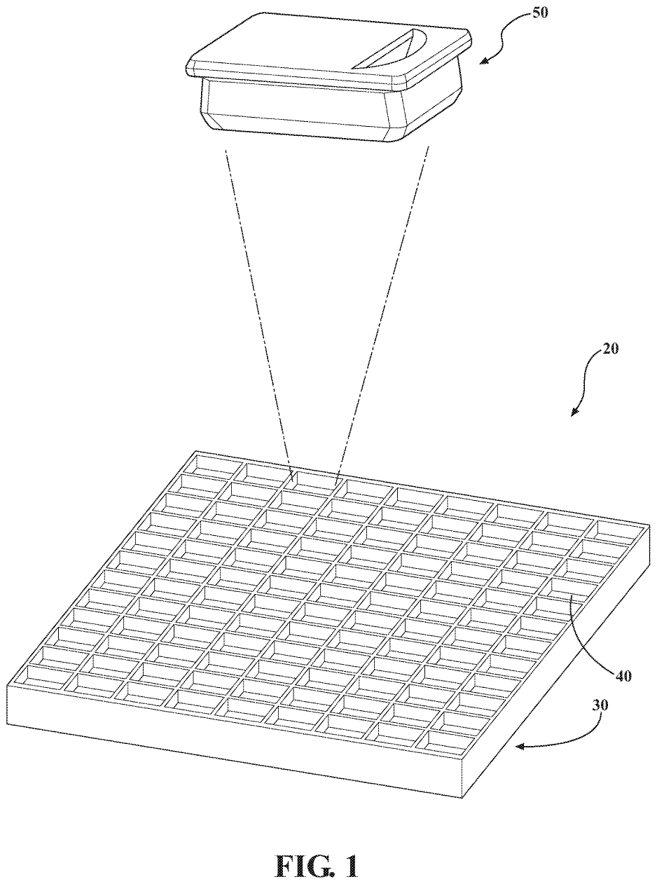

FIG. 1 schematically illustrates a container assembly 20 that generally includes a tray 30 with a multiple of compartments 40, each of which has a cover 50. The container assembly 20 may be used for storing and organizing small electronic components such as resistors and capacitors, small fasteners, craft items, and many other small items.

In embodiments, the compartments 40 may be rectangular in shape. Rectangular compartments 40 have rectangular covers and rectangular covers 50 have the advantage of being able to be put in place backwards. A cover 50 put in place backwards can be used as an indicator that the compartment is empty or low on parts. Other shapes can also be put on in more than one orientation, for example equilateral triangles and regular hexagons.

The size and number of compartments in a tray depends on what items may be stored therein. The shape would typically be rectangular, with the length, width, and depth again being dependent on the items being stored. The number of compartments in a tray will depend on the application. For example, one hundred (100) or more compartments in a tray provides easy access to a large assortment of parts. In other cases, it might be useful to have a tray with a much smaller number of compartments. For example, if there is a repair job that gets done frequently and only 15 different parts are ever needed for the repair, a tray with 15 compartments might be convenient.

For many applications, all compartments will be the same size, but that is not required. A tray could have several different sized compartments, although each may typically have the same depth.

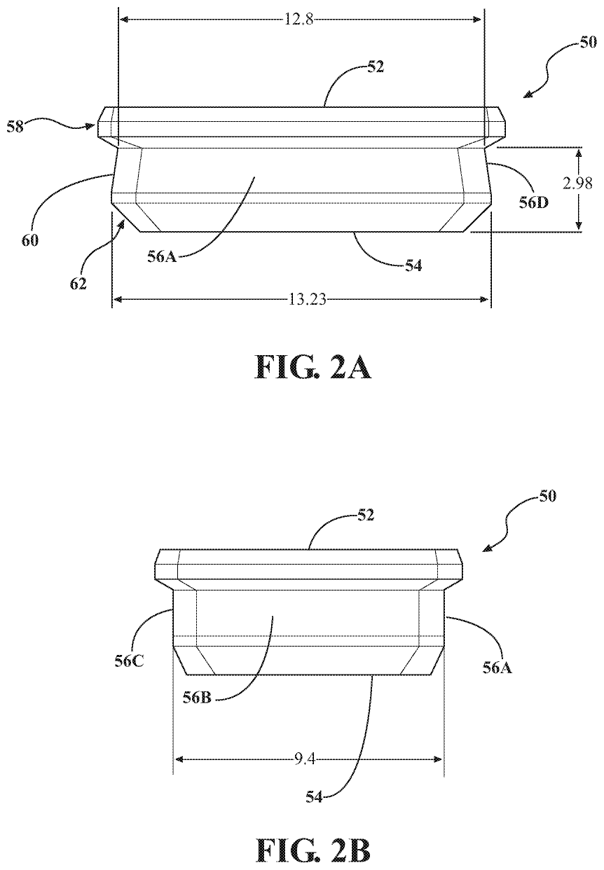

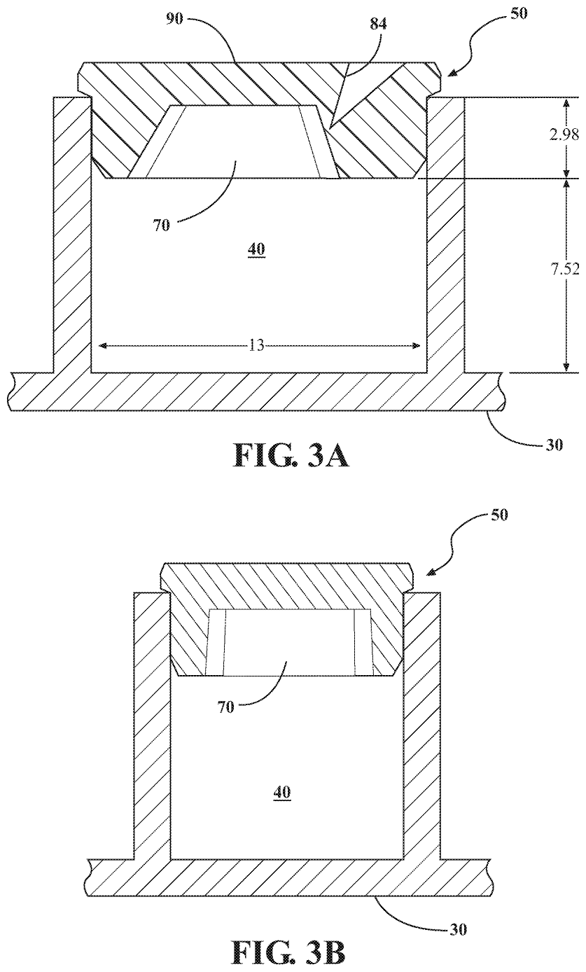

With reference to FIGS. 2A, 2B, and FIGS. 3A, 3B, in the embodiment in which the stored items may be resistors, the cover 50 may generally include a top section 52, a bottom section 54, and sides 56A-56D. The cover 50 may further include a flanged upper section 58 in which the top section 52 is larger than a periphery 60 defined by the sides 56A-56D of the cover 50 as well as the periphery of the compartment 40.

The cover 50 may further include a chamfered bottom section 62 that is smaller than the periphery 60 of the cover 50 as well as the periphery of the compartment 40. The chamfered bottom section 62 and the flanged upper section 58 facilitates installation and removal of the cover from each individual compartment 40. The compartment 40 is sized to provide an interference fit with the cover 50, that is, the cover 50 operates to plug into an associated compartment 40 and remains therein via friction. In this embodiment, the compartment may be about 13 mm long, and the cover 50 extends into the compartment 40 for a depth of about 2.98 mm into a 10.5 mm deep compartment (FIGS. 3A, 3B) with the flanged upper section 58 resting above the lip of the compartment 40.

In embodiments, the cover 50 may be manufactured of a pliable material such as a thermoplastic elastomer, rubber, silicone, flexible 3D filament, etc. The tray 30 and the covers 50 may be manufactured using injection molding or using fused filament fabrication, commonly called 3D printing or additive manufacturing. Alternatively, or in addition, the tray 30 and the covers 50 may be manufactured of an at least partially translucent material to visually identify the items.

In embodiments, the interference fit need not be equivalent along both axes and may, in embodiments, be greater along the longitudinal axis (FIGS. 2A and 3A). That is, the dimension along the lateral axis (FIGS. 2B and 3B) may provide a clearance fit while the longitudinal axis (FIGS. 2A and 3A) provides the interference fit. In one embodiment in which the compartment 40 is 13 mm, the longitudinal axis (FIGS. 2A and 3A) of the cover 50 is between 101-105% the length of the longitudinal length of the compartment 40, and in one embodiment is about 103.4% the length of the longitudinal length of the compartment 40.

The process of removing the cover 50 from the cavity 40 involves applying a force parallel to the top surface of the cover and also a force perpendicular to that surface to lift it away from the compartment. The force parallel to the surface has the effect of compressing the springiness of the cover. But compressing the cover 50 in one axis causes it to expand slightly in the horizontal axis perpendicular to the force. For that reason, the cover may be fabricated slightly narrower in the lateral axis (FIGS. 2B and 3B) where the expansion occurs to minimize or eliminate binding.

In embodiments, one or more walls of the compartment 40 and/or the cover 50 may include a textured section to increase the friction to retain the covers 50.

In embodiments, the bottom section 54 of the cover 50 may include a bottom recess 70 (FIGS. 3A and 3B) to further increase storage space in the compartment 40, reduce cost, and/or reduce the stiffness of the cover 50. The recess 70 may alternatively or additionally be shaped to at least partially conform to an item within the compartment 40.

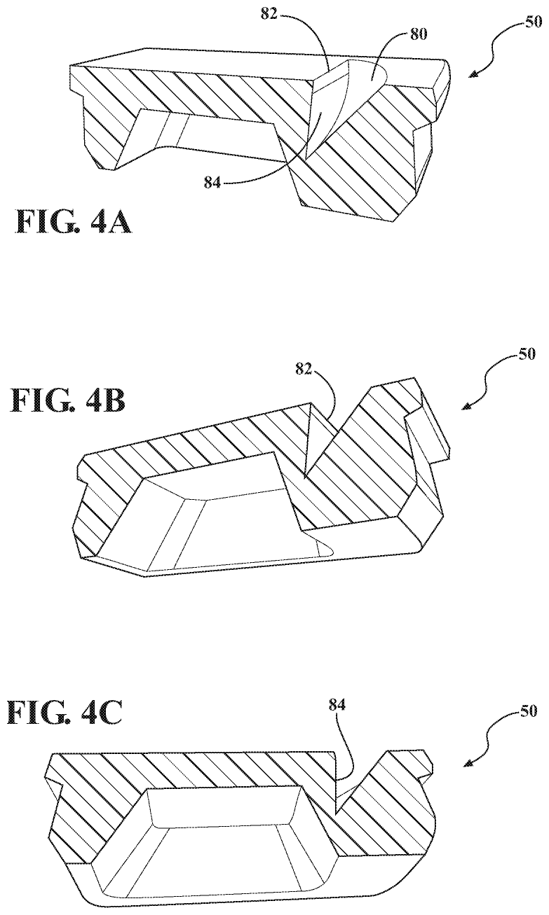

With reference to FIG. 4A-4C, in embodiments, the top section 52 of the cover 50 may include a recess 80 to facilitate the removal of the cover 50. The top recess 80 may be essentially fingernail shaped with a lip 82 and an undercut 84 to facilitate grip by a fingernail, or tool. That is, the undercut 84 forms an acute angle with the surface of the top section 52 (best seen in FIG. 3A). The top recess 80 maintains a planar top surface to facilitate stacking of the trays as well as a marking section area 90 on each cover 50. In embodiments, the markings can be adhesive labels, printed, molded when fabricated, achieved with a laser, etc. The laser may alter or remove pigment in the cover, rather than etching into the cover or burning it to change its color. The end result is a marking of a lighter color than the surrounding material of the cover. An ultraviolet laser works well to remove or change the color of pigments in plastics.

Each cover may be marked after it is in place based on its location. That means that there is one generic cover that gets used on all similar compartments rather than having to stock a separate cover for each compartment. In the example of 1% tolerance resistors, there are 673 standard values covering the range from 1 Ω to 10 MegΩ. If the covers are marked after they are placed on the trays, only one generic unmarked cover needs to be stocked rather than the 673 needed if they are marked before being placed.

In embodiments, the tray 30 and/or the cover 50 may alternatively or additionally be color coded. In the case of an assortment of resistors, it might take several trays to provide enough compartments for all the values that an application might require. In this case, one might choose colors that indicate the resistance range of the resistors in the tray. For example:
gold 1.00 Ω-9.76 Ω
black 10.0 Ω-97.6 Ω
brown 100 Ω-976 Ω
red1.00 kΩ-9.76 kΩ
orange 10.0 kΩ-97.6 kΩ
yellow 100 kΩ-976 kΩ
green 1.00 MΩ-9.76 MΩ

Color coding the trays can be useful, but in many cases color coding by itself would not be enough to identify the contents of a tray. Using surface mount resistors as an example, there are many different physical sizes of resistors that all have the same resistance. So one might have four red trays each containing resistors in the range of 1.00 kΩ through 9.76 kΩ. The four trays would be for different physical sizes of resistors, for example, 0402, 0603, 0805, and 1206. A marking on the tray itself in addition to the markings on the compartment covers might be needed.

In order to reduce the chance of damage to static sensitive parts, the tray 30 and cover 50 may be manufactured of a material that is conductive enough to be static safe. Even for parts that are not static sensitive, if they are small enough, static charge buildup on the tray could be a nuisance. Small parts might cling to the covers or walls of the compartments due to static charge. Using a static safe material for the trays and covers can reduce or eliminate that problem.

In an embodiment in which the stored items are to be resistors, an approximately 5″×5″ tray can hold over 100 different values. The trays stack one on top of another, and a stack of seven trays holding the entire E96 series of resistor values from 1 Ω to 10 MegΩ is less than four inches tall. The parts are easy to locate because one small tray can have over 100 compartments and the compartment markings can be on the cover top. Although the contents of each compartment are not visible without removing the cover, putting the cover on backwards is a simple way to indicate an empty compartment. Existing pick and place machinery can be used to initially load the trays with parts and put the covers in place.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A cover for a container assembly, comprising:
a top section;
a bottom section;
a first and second longitudinal side between the top section and the bottom section; and
a first and second lateral side between the top section and the bottom section.

2. The cover as recited in claim 1, further comprising a recess in the top section, the recess comprises a lip and an undercut, the undercut forms an acute angle with the surface of the top section, wherein the recess is fingernail shaped.

3. The cover as recited in claim 1, further comprising a flanged upper section about the top section, the flanged upper section defines a periphery larger than a periphery defined by the sides.

4. The cover as recited in claim 1, further comprising a chamfered bottom section about the bottom section, the chamfered bottom section defines a periphery smaller than a periphery defined by the sides.

5. The cover as recited in claim 1, wherein the first and second longitudinal side define an interference fit within a compartment in a tray within which the cover is installed.

6. The cover as recited in claim 5, wherein the interference fit is between 101-105% the length of the longitudinal length of the compartment.

7. The cover as recited in claim 5, wherein the first and second lateral side define a clearance fit within a compartment in a tray within which the cover is installed.

8. The cover as recited in claim 1, wherein the first and second longitudinal side define an interference fit within a compartment in a tray within which the cover is installed and the first and second lateral side define a clearance fit within a compartment in a tray within which the cover is installed.

9. The cover as recited in claim 8, wherein the interference fit is between 101-105% the length of the longitudinal length of the compartment.

10. The cover as recited in claim 8, wherein the cover and the tray are additively manufactured.

11. The cover as recited in claim 8, wherein the cover and the tray are additively manufactured of different materials.

12. The cover as recited in claim 8, wherein the cover and the tray are injection molded.

13. The cover as recited in claim 8, wherein the cover and the tray are injection molded of different materials.

14. The cover as recited in claim 1, further comprising a recess in the bottom section.

15. A container assembly, comprising:
a tray with a multiple of compartments;
a cover that fits at least partially within at least one of the multiple of compartments, the cover comprises:
a top section;
a first and second longitudinal side between the top section and a bottom section; and
a first and second lateral side between the top section and the bottom section, wherein the first and second longitudinal side define an interference fit within a compartment in a tray within which the cover is installed and the first and second lateral side define a clearance fit within the compartment in the tray within which the cover is installed.

16. The assembly as recited in claim 13, further comprising a recess in the top section, the recess comprises a lip and an undercut that forms an acute angle with the surface of the top section.

17. The assembly as recited in claim 13, wherein an interference fit is between 101-105% the length of the longitudinal length of the compartment.
